(19) United States
(12) Patent Application Publication
(10) Pub. No.: US 2010/0045801 A1
(43) Pub. Date: Feb. 25, 2010

(54) System For Inputting Word-Image Into Information Device And Method For Inputting Word-Image

(75) Inventors: Sang Woo Lee, Seoul (KR); Choung Suk Oh, Seoul (KR); Min Uk Kang, Seoul (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: UNICHAL Inc., Seoul (KR)

(21) Appl. No.: 12/524,738

(22) PCT Filed: Nov. 29, 2007
(86) PCT No.: PCT/KR07/06094

§ 371 Date: Jul. 28, 2009

(30) Foreign Application Priority Data
Apr. 20, 2007 (KR) 19-2007-0038791

(51) Int. Cl. H04N 5/225; G06F 3/00

(52) U.S. Cl. 348/207.1; 382/100; 348/370; 348/E05.024; 348/E05.029; 704/E15.005

(57) ABSTRACT

Disclosed are a word-image input system and a word-image input method, and more particularly, to a system for inputting an word-image into an information device and a method thereof that can enable the information device to read the word-image formed by placing a printed matter printed with words having a complicated language system at a proper location and pho-tographing the printed matter at optimized illuminance and distance. According to the present invention, it is possible to prevent the recognition rate for the word-image from being lowered due to shaking, spreading phenomenon and unstable illuminance when the word-image is recognized by the information device provided with the word recognition application. In addition, it is possible to easily input words such as Chinese having a complicated language system into the information device

### TECHNICAL FIELD

The present invention relates to a word-image input system and a word-image input method, and more particularly, to a system for inputting an word-image into an information device and a method thereof that can enable the information device to read the word-image formed by placing a printed matter printed with words having a complicated language system at a proper location and photographing the printed matter at optimized illuminance and distance.

### BACKGROUND ART

A conventional word recognition system includes a camera 10 photographing a printed matter and an information device 20 interpreting an image formed by the camera 10 into a character.

However, there is a problem that the word input system is unsuitable for inputting only a particular word into the information device 20 because the image of the printed matter inputted by the word input system includes many characters in the entire region photographed by the camera.

Furthermore, there is another problem that a recognition rate is lowered because the photographed image of the printed matter is shaken or spread by change of a focal length between the printed matter (including handwritten matters) to be inputted and the camera and shaking phenomenon, or the illuminance is not constant.

A technology of inputting an image of a printed matter scanned by a scanner into the information device 20 has been proposed to solve problems such as shaking, spreading phenomenon and inconstant illuminance as described above. However, the technology has a problem that the recognition rate for words recorded on the printed matter is lowered due to discordant scan starting points and inconstant scan speed.

In addition, a conventional technology for inputting only a particular word into the information device 20 by using a keyboard has been proposed.

However, the technology using the keyboard has a problem that it is difficult to input words such as Chinese having a complicated language system.

### DISCLOSURE OF THE INVENTION

### Technical Problem

Therefore, the present invention has been made to solve the above-mentioned problems occurring in the prior art, and an object of the present invention is to form a word-image by photographing a printed matter recorded with words in an optimum environment, and to provide the word-image to a word recognition information system.

Additional advantages, objects, and features of the invention will be set forth in part in the description which follows and in part will become apparent to those having ordinary skill in the art upon examination of the following or may be learned from practice of the invention.

### Technical Solution

According to an aspect of the present invention, there is provided a word-image input system, which includes: a word-image input device, an information device provided with a word recognition application for receiving a word-image formed by the word-image input device and reading words recorded in the word-image by recognizing the words, and a transmission interface provided in the word-image input device for transmitting the word-image formed by the word-image input device to the information device according to a control instruction of a controller of the word-image input device, where the word-image input device includes: a document stage whose bottom surface is flat so as to be placed on a printed matter recorded with words, being marked with a plurality of reference points; a body, assembled with or formed integrally with the document stage, including a hanger unit provided with a pivot part for supporting a device recognizing the words of the printed matter; a reference setting illumination unit, combined with the pivot part of the hanger unit, marking a plurality of reference points for placing the printed matter recorded with words on the document stage by emitting light while moving in a predetermined angle; an illuminance setting illumination unit, connected to an illuminance sensor, setting an illuminance automatically so as to keep a constant illuminance suitable for recognizing the words of the printed matter placed by using at least one of the plurality of reference points marked on the document stage by the reference setting illumination unit; a camera forming a word-image by photographing the words recorded on the printed matter placed at the reference point marked by the reference setting illumination unit in the illuminance set by the illuminance setting illumination unit; a controller, controlling the reference setting illumination unit, illuminance setting illumination unit and camera so as to form the word-image, transmitting the formed word-image; and a switch for supplying power to the reference setting illumination unit, illuminance setting illumination unit, camera and controller.

According to another aspect of the present invention, there is provided a method of inputting a word-image into an information device, which includes: setting a reference point by using light emitted by a reference setting illumination unit and at least one of a plurality of reference points marked on a document stage whose bottom surface is flat so as to be placed on a printed matter recorded with words; automatically setting an illuminance suitable for photographing the printed matter by a camera by placing the printed matter recorded with words about the set reference point and connecting an illuminance setting illumination unit provided on the document stage with an illuminance sensor; forming a word-image by photographing the printed matter recorded with words by the camera that is fixed to a hanger unit connected to the document stage so as to keep a focal length for an optimum resolution in the set illuminance; transmitting the word-image formed by the camera to an information device through a transmission interface; and reading the word-image transmitted through the transmission interface by recognizing the words using a word recognition application installed in the information device.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a construction view illustrating a conventional word-image input system;

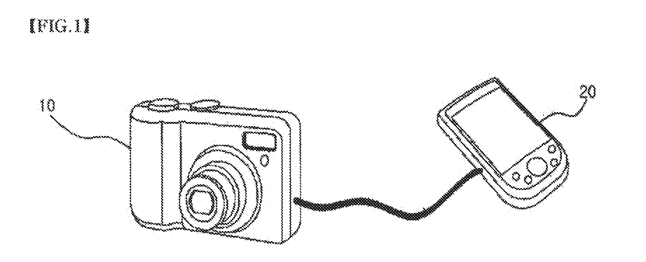

FIG. 2 is a construction view illustrating a word-image input system according to the present invention;

FIG. 3 is a sectional view illustrating a pivot part of the image input system according to the present invention; and

FIG. 4 is a flow chart illustrating a method of inputting a word-image according to the present invention.

### MODE FOR CARRYING OUT THE INVENTION

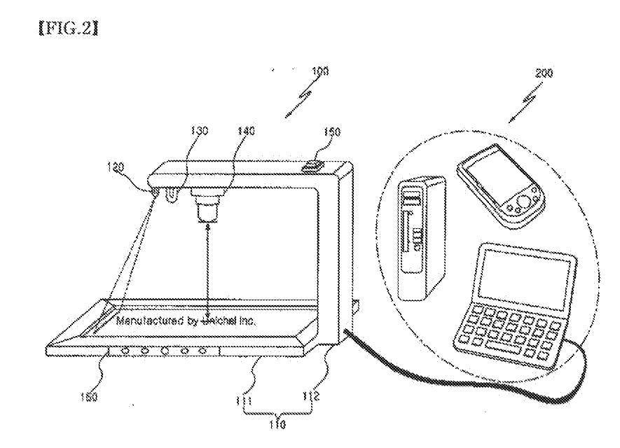

Referring to FIG. 2, a word-image input system according to the present invention includes a word-image input device 100 generating a word-image recorded with words and an information device 200 receiving the word-image and outputting words.

Particularly, the word-image input device 100 includes a body 110, a reference setting illumination unit 120, an illuminance setting illumination unit 130, a camera 140 and a switch 150.

More particularly, the body 110 includes a document stage 111 and a hanger unit 112 assembled or integrally formed in any one side of the document stage 111. An upper surface of the document stage is flat. Thus, a printed matter recorded with words can be placed on the document stage without folding or shaking, thereby allowing the words recorded on the printed matter to be easily photographed. The reference setting illumination unit 120, illuminance setting illumination unit 130, camera 140 and switch 150 are provided at the hanger unit (112) and spaced by a predetermined distance from the upper surface of the document stage 111.

The predetermined distance is a focal length fixed for photographing the words of the printed matter at an optimized distance.

In addition, the word-image input device 100 includes a controller 160 in the body 110 for controlling the reference setting illumination unit 120, illuminance setting illumination unit 130, camera 140 and switch 150 and transmitting the word-image to the information device 200.

The controller 160 includes a transmission interface for transmitting the word-image photographed by the camera 140 to the information device 200. The transmission interface may be any one of USB (Universal Serial Bus), IrDA (Infrared Data Association), UART (Universal Asynchronous Receiver Transmitter), WUSB (Wireless Universal Serial Bus), Bluetooth and zigBee.

The reference setting illumination unit 120 is assembled to the hanger unit 112 and marks a reference point for placing the printed matter on the document stage 111 by using infrared light or laser light.

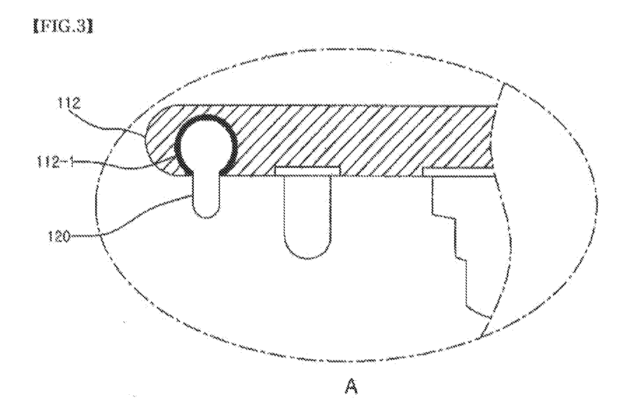

Therefore, the reference setting illumination unit 120 should be moved at a predetermined angle for positioning the reference point to the printed matter to be placed. Thus, as shown in FIG. 3, it is desirable that the reference setting illumination unit 120 is assembled with the pivot part 112-1 formed at the hanger unit 112 and a reference point for a desired location is marked according to movement of the reference setting illumination unit 120 assembled with the pivot part at a predetermined angle.

Thus, the reference point for the desired location is marked on the document stage 111 by light emitted from the reference setting illumination unit 120 assembled with the pivot part 112-1 and the printed matter is placed on the reference point.

As a result, scan speed and recognition rate are improved by providing the reference setting illumination unit 120 mechanically stably. In other words, in the conventional method of scanning the printed matter, the instable scan speed and decrease of recognition rate caused by discordance of reference points can be prevented.

The illuminance setting illumination unit 130 is fixed to the hanger unit 112 and provides a constant illuminance to the printed matter photographed by the camera 140. In other words, the illuminance setting illumination unit 130 keeps a constant illuminance set by a user always because a recognition rate for words recorded on the photographed word-image may be lowered in various cases such as that weather is changed or the word-image input device 100 is moved to other place

In addition, it is desirable that the illuminance setting illumination unit 130 is an LED and can manually control an illuminance or automatically control the illuminance by being connected to an illuminance sensor.

The camera 140 is fixed to the hanger unit 112 and photographs the printed matter placed on the upper surface that is formed to place the printed matter on the document stage 111 easily.

Accordingly, it is desirable that the camera 140 is fixed to the hanger unit 112 according to a focal length set optimally between the camera 140 and printed matter. That is the reason that a display of the camera 140 has a function of automatically focusing in proportion to a distance of an object for expressing the object clearer than peripheral environment.

The switching unit 150 supplies power to the reference setting illumination unit 120, illuminance setting illumination unit 130 and camera 140, thereby allowing them to operate.

The information device 200 receives the word-image formed by the word-image input device 100 including the body 110, reference setting illumination unit 120, illuminance setting illumination unit 130, camera 140 and switch 150, and recognizes the words recorded in the word-image.

In addition, the information device 200 may be a PC (Personal Computer), a PDA (Personal Digital Assistant) and an electronic dictionary in which a word recognition application has been installed.

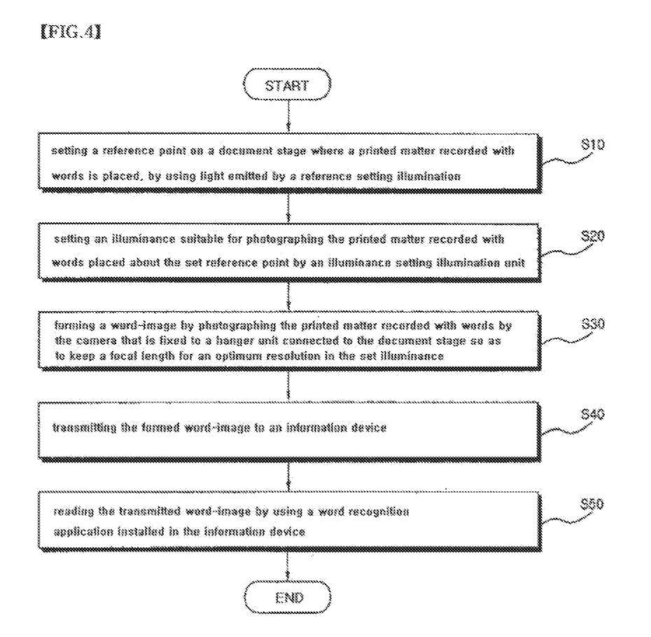

FIG. 4 shows a flow chart illustrating a method of inputting a word-image according to the present invention.

The word-image input method includes the steps of: setting a reference point at a document stage where a printed matter recorded with words is placed by using light emitted by a reference setting illumination unit (S10); setting an illuminance suitable for photographing the printed matter recorded with words placed about the set reference point (S20); forming a word-image by photographing the printed matter recorded with words by the camera that is fixed to a hanger unit connected to the document stage so as to keep a focal length for an optimum resolution in the set illuminance (S30); transmitting the formed word-image to an information device (S40); and reading the transmitted word-image by a word recognition application installed in the information device (S50).

More particularly, in the step S10, as shown in FIG. 3, the word input system includes the word-image input device 100 and information device 200. The word-image input device 100 includes the body 110, reference setting illumination unit 120, illuminance setting illumination unit 130, camera 140 and switch 150. The body 110 includes the document stage 111 whose upper surface is flat so as to place the printed matter recorded with words thereon without folding or shaking for easily photographing the words of the printed matter, and the hanger unit 112 assembled or integrally formed in any one side of the document stage 111. The reference setting illumination unit 120, illuminance setting illumination unit 130, camera 140 and switch 150 are provided to the hanger unit 112 with being spaced by a predetermined distance from the upper surface of the document stage 111.

In addition, the body 110 includes the controller 160 for controlling the reference setting illumination unit 120, illuminance setting illumination unit 130, camera 140 and switch 150, and transmitting the photographed words to the information device 200.

According to the construction as described above, the reference setting illumination unit 120 marks the reference point for placing the printed matter recorded with words by irradiating infrared or laser light at one side of the upper surface of the document stage 111 where the printed matter is placed. Thus, the reference point is set by placing the document on the flat bottom of the document stage 111 of the word-image input device 100 by using at least one of the plurality of reference points marked on the document stage 111. In other words, the word-image input device 100 is placed on the printed matter recorded with words and then the printed matter recorded with words is photographed by the camera 140.

In the step S20, the printed matter recorded with words is placed according to the reference point by a user after the reference setting illumination unit 120 marks the reference point for placing the printed matter recorded with words to be photographed on the document stage 111. Then, the illuminance setting illumination unit 130 fixed to the hanger unit 112 controls the illuminance constantly so as to photograph the printed matter recorded with words in the optimum illuminance.

In other words, the illuminance setting illumination unit 130 keeps the illuminance constantly always because the recognition rate for words recorded on the photographed word-image may be lowered in various cases such as that weather is changed or the word-image input device is moved to other place.

In addition, it is desirable that the illuminance setting illumination unit 130 is an LED and can manually control the illuminance or automatically control the illuminance by being connected to the illuminance sensor.

Particularly, the document stage 111 is formed flat so as to obtain the word-image suitable for recognizing the photographed words by preventing folding of the printed matter recorded with words. In addition, the middle portion of the document stage is formed to be concaved for placing the printed matter recorded with words without folding. The light emitted from the illuminance setting illumination unit 130 is uniformly dispersed to the printed matter recorded with words because the document stage 111 is formed flat.

In the step S30, the camera 140 is fixed to the hanger unit 112. The word-image is formed by photographing the printed matter placed on the upper surface that is formed to easily place the printed matter thereon. Then, the word-image is temporarily stored in a storage medium included in the controller 160.

The word-image is temporarily stored in the storage medium for reading the words sequentially in the information device. Thus, it is more efficient to transmit the word-image sequentially after temporary storage than continuously transmitting the photographed word-image.

Thus, it is desirable that the camera 140 is fixed to the hanger unit 112 with an optimized distance between the camera 140 and printed matter. That is the reason that the display of the camera 140 has a function of automatically focusing in proportion to a distance of an object for expressing the object clearer than peripheral environment.

In the step S40, the word-image formed by the camera 140 is transmitted to the information device 200 through the transmission interface provided in the controller 160.

The transmission interface may be any one of USB, IrDA, UART, WUSB, Bluetooth and zigBee.

In the step S50, the information device 200 receives and stores the word-image formed by the word-image input device 100 including the body 110, reference setting illumination unit 120, illuminance setting illumination unit 130, camera 140 and switch 150, and reads the words recorded in the stored word-image by the word recognition application installed in the information device 200.

In addition, the information device 200 may be a PC, a PDA and an electronic dictionary in which the word recognition application has been installed.

### INDUSTRIAL APPLICABILITY

According to the present invention, the following effects are obtained.

First, it is possible to prevent the recognition rate for the word-image from being lowered due to shaking, spreading phenomenon and unstable illuminance when the word-image is recognized by the information device provided with the word recognition application.

Second, it is possible to easily input words such as Chinese having a complicated language system into the information device.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A word-image input system, comprising a word-image input device,
an information device provided with a word recognition application for receiving a word-image formed by the word-image input device and reading words recorded in the word-image by recognizing the words, and
a transmission interface provided in the word-image input device for transmitting the word-image formed by the word-image input device to the information device according to a control instruction of a controller of the word-image input device,
where the word-image input device comprises: a document stage whose bottom surface is flat so as to be placed on a printed matter recorded with words, being marked with a plurality of reference points;
a body, assembled with or formed integrally with the document stage, including a hanger unit provided with a pivot part for supporting a device recognizing the words of the printed matter;
a reference setting illumination unit, combined with the pivot part of the hanger unit, marking a plurality of reference points for placing the printed matter recorded with words on the document stage by emitting light while moving in a predetermined angle;
an illuminance setting illumination unit, connected to an illuminance sensor, setting an illuminance automatically so as to keep a constant illuminance suitable for recognizing the words of the printed matter placed by using at least one of the plurality of reference points marked on the document stage by the reference setting illumination unit;
a camera forming a word-image by photographing the words recorded on the printed matter placed at the reference point marked by the reference setting illumination unit in the illuminance set by the illuminance setting illumination unit;
a controller, controlling the reference setting illumination unit, illuminance setting illumination unit and camera so as to form the word-image, transmitting the formed word-image; and
a switch for supplying power to the reference setting illumination unit, illuminance setting illumination unit, camera and controller.

2. The word-image input system of claim 1, wherein the reference setting illumination unit marks the reference point on the document stage by using infrared light or laser light.

3. The word-image input system of claim 1, wherein the information device is any one of PC, PDA and electronic dictionary in which the word recognition application has been installed.

4. The word-image input system of claim 1, wherein the transmission interface transmits the word-image by any one of USB, IrDA, UART, WUSB, Bluetooth and zigBee.

5. A word-image input method comprising: setting a reference point by using light emitted by a reference setting illumination unit and at least one of a plurality of reference points marked on a document stage whose bottom surface is flat so as to be placed on a printed matter recorded with words (S10);
automatically setting an illuminance suitable for photographing the printed matter by a camera by placing the printed matter recorded with words about the set reference point and connecting an illuminance setting illumination unit provided on the document stage with an illuminance sensor (S20);
forming a word-image by photographing the printed matter recorded with words by the camera that is fixed to a hanger unit connected to the document stage so as to keep a focal length for an optimum resolution in the set illuminance (S30);
transmitting the word-image formed by the camera to an information device through a transmission interface (S40); and
reading the word-image transmitted through the transmission interface by recognizing the words using a word recognition application installed in the information device (S50).

6. The word-image input method of claim 5, wherein in the step S10, the light emitted from the reference setting illumination unit is infrared light or laser light.

7. The word-image input method of claim 5, wherein in the step S40, the word-image is transmitted through any one of USB, IrDA, UART, WUSB, Bluetooth and zigbee.

8. The word-image input method of claim 5, wherein the information device is any one of PC, PDA and electronic dictionary in which the word recognition application has been installed.
